(19) United States
(12) Patent Application Publication
(10) Pub. No.: US 2017/0283326 A1
(43) Pub. Date: Oct. 5, 2017

(54) APPARATUS AND METHODS

(71) Applicant: Smart Separations Limited, London (GB)

(72) Inventors: Hugo Miguel Magalhaes Macedo, Coulsdon (GB); Richard Drinkwater, Sevenoaks (GB)

(21) Appl. No.: 15/629,088

(22) Filed: Jun. 21, 2017

Related U.S. Application Data
(63) Continuation-in-part of application No. PCT/GB2016/050011, filed on Jan. 5, 2016.

(30) Foreign Application Priority Data
Jan. 6, 2015 (GB) 1500121.7
Jun. 22, 2016 (GB) 1610927.4

(51) Int. Cl. C04B 35/111; C04B 35/46; C04B 35/486; C04B 35/14

(52) U.S. Cl. CPC C04B 35/111; C04B 35/14; C04B 35/46; C04B 35/486; C04B 2111/00793

(57) ABSTRACT

We describe an apparatus for controlling a thickness of a workpiece element, the apparatus comprising: a lapping machine having a lapping plate; and a holder to hold a workpiece element; wherein said holder comprises: a workpiece element mount to mount a workpiece element to be lapped such that a surface of said workpiece element lies substantially flush with a lower face of said holder; an adjustable actuator to controllably move said surface of said workpiece element so that it remains substantially flush or projects beyond said lower face of said holder during lapping; means for urging said holder towards said lapping plate; and a sensor for sensing a displacement of the workpiece element towards said lapping plate.

### RELATED APPLICATION DATA

This application is a continuation-in-part of International Patent Application No. PCT/GB2016/050011, filed Jan. 5, 2016, which claims priority to UK Application Nos. 1610927.4, filed Jun. 22, 2016 and 1500121.7, filed Jan. 6, 2015, the disclosures of the International and UK applications are incorporated herein by reference in their entireties.

### FIELD OF THE INVENTION

This invention relates to apparatus and methods for manufacturing a work product from a workpiece element. In particular the manufacture of ceramic filters or ceramic parts from ceramic workpiece elements.

### BACKGROUND TO THE INVENTION

It is known to fabricate filters from thin plastic films using track-etch techniques, bombarding the films with charged particles and subsequently performing a chemical etch. Another technique uses a laser beam to drill pores in a polymeric membrane. A third approach is to employ lithography. However these filters tend to be weak, expensive and unsuitable for many applications.

In principle ceramic materials should be advantageous for microfiltration, but there is no easy technique for producing on-demand defined circular pore sizes.

Background Prior Art can be Found in:
U.S. Pat. No. 6,479,099B
U.S. Pat. No. 5,340,779A
EP1020276A
US2004091709A
US2002074282A
WO03072233A
US2007142208A
US2011100910A
US2008022644A
US2007119135A
U.S. Pat. No. 4,746,341A
US2006192326A
KR100445768B
JP2009227555A

Further background prior art can be found in: “Preparation, Characterization And Permeation Property Of Al₂O₃, Al₂O₃—SiO₂ And Al₂O₃-Kaolin Hollow Fiber Membranes”, Han Et Al. Journal Of Membrane Science, Volume 372, Issues 1-2, 15 Apr. 2011, Pages 154-164; and in “Optimization Of Hybrid Hyperbranched Polymer/Ceramic Filters For The Efficient Absorption Of Polyaromatic Hydrocarbons From Water”, Tsetsekou A. Et Al. Journal Of Membrane Science, Volume 311, Issues 1-2, 20 Mar. 2008, Pages 128-135.

The amount of lapping (or the removal of material) from an object to smoothen its surface or “flatten” it, has been traditionally employed using time as the main variable to control this removal of material. The principle relies on the fact that the longer the lapping time, the more material is removed, and hence thinner the treated material. However, it is known in the field that environmental conditions, such as temperature and humidity, influence the rate of material removal. This results in large discrepancies, and the requirement for tighter quality control to achieve the required result.

### SUMMARY OF THE INVENTION

### Ceramic Filters

We have previously described (in WO2015/004468, unpublished at the priority date of the present application), a method of manufacturing a ceramic filter having a controlled filter channel opening size, the method comprising: fabricating a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise ceramic material; and sintering said ceramic precursor element to fuse said ceramic material and remove said polymer material; the method further comprising removing a controlled thickness portion of said first surface to open said flared pores to said controlled filter channel opening size.

In embodiments the ceramic precursor element is fabricated by forming a dope into a desired shape for the element, the dope comprising the ceramic material, the polymer, and a solvent for the polymer. The formed shape is then treated in a bath of liquid in which the solvent (but not the polymer) is miscible. For example a polar solvent in combination with an aqueous (water) bath may be employed. Broadly speaking during treatment the solvent is replaced by the liquid (water) in the bath in a manner which forms convection cells leaving a substantially regular arrangement of generally conical pores extending between the surfaces of the precursor element. In principle inorganic materials other than ceramic materials may be employed. The apexes of the flared pores do not quite reach the first surface, although in embodiments they may just intersect this surface leaving very small apertures, for example less than 0.1 μm, if the element comprises a very thin membrane. During firing the polymer material is burnt off leaving flared apertures in the sintered ceramic. Then by removing a controlled thickness layer of material from the first surface the flared pores can be opened to a desired extent.

The precursor element may, in embodiments, comprise a thin sheet or membrane of material, or a tube of material. A portion of the first surface may be removed by depositing a solvent onto this surface, preferably of the same class (polar or non-polar) as that in the ceramic precursor and leaving the solvent to dissolve a thin layer of the first surface, optionally aided by shaking. For example solvent may be poured onto the top of a membrane or a tubal fibre may be dipped into a solvent. The solvent is left for a period of, for example, of order 1 minute to of order 24 hours, the dissolution process being halted by placing the ceramic precursor into an oven for sintering.

Additionally or alternatively a portion of the first surface of the ceramic precursor element may be removed physically, for example by means of a controlled height cutter such as a knife blade on an adjustable lead screw—such an arrangement can typically control the thickness of material removed to better than 1 μm. This process may be performed dry or with lubricant, before sintering. After sintering material may be removed by abrasion, for example using a controllable height spinning abrading disc such as a diamond polisher, or by employing a sandpaper-like abrasion process employing ceramic particles of a similar material to the ceramic material in the filter—for example micron scale or sub-micron scale aluminium oxide particles, diamond, and/or silicon oxide. In another approach, fibre optic lapping film may be used to abrade the surface; this may employ a variety of materials, such as silicon oxide, diamond, aluminium oxide, titanium dioxide, and so forth.

We also described a ceramic filter having a structure comprising first and second surfaces and an arrangement of flared passageways extending between and connecting with said first and second surfaces.

In embodiments the conical pores in the ceramic precursor are all substantially the same size and have substantially the same included angle at the apex. Thus by removing material from the first surface the size of the pores can be accurately controlled—although in practice embodiments of the technique we describe tend to place an upper limit on the maximum dimension (diameter) of the opening of a pore—which is a useful property for a filter.

Embodiments of the filter structure have flared passageways, which is useful in reducing the risk of obstruction/blocking. Typical filter pore diameters are in the range 0.1-20 μm, although larger pores may be fabricated (limited by the size of the pore at the second surface, which depends on the thickness of the element). Thus in embodiments of a filter fabricated by the process the flared passages are generally circular and more than 90% have a diameter (at one or both ends) of greater than 0.1 μm, 0.2 μm, 0.5 μm or 1 μm. In embodiments the opening of the passages may have a diameter (at one or both ends) of less than 100 μm, 50 μm, 30 μm, 20 μm, 10 μm, 5 μm or 2 μm. This is useful as such pore sizes are difficult to produce reliably by other techniques.

One advantageous application of a filter manufactured by the above described technique is in separating components of blood, in particular separating red blood cells from other blood components. For example platelets may have a diameter of less than 1 μm, red blood cells may have a dimension of around 7 μm, and white blood cells, and other cells in the blood such as stem cells, may have a dimension in the range of 10-20 μm. Thus by selecting a pore size of less than 5 μm, 4 μm, 3 μm or 2 μm (a red blood cell may squeeze through a hole as small as 1-3 μm) a leukoreduction filter may be fabricated. Conventional blood filtration apparatus can lose of order 5-10% of red blood cells in the filtration process, but blood filtration apparatus incorporating ceramic filter of the type we have described can be substantially more efficient. In addition the quality of the residue is enhanced and the residue may be recovered to extract material such as stem cells or white blood cells, for example for research.

Although embodiments of the techniques we have described are particularly useful for fabricating filters with a controlled pore dimension, they may more generally be employed for fabricating a ceramic filter element without necessarily controlling the pore dimension and, potentially, employing other inorganic materials than ceramic materials.

Thus we also described a method of manufacturing an inorganic filter, the method comprising: fabricating a precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise inorganic material; and sintering said precursor element to fuse said inorganic material and remove said polymer material; the method further comprising removing a portion of said first surface to open said flared pores.

The previously described techniques may all be employed in embodiments of this aspect of the invention. In particular a portion of the first surface may be removed physically and/or chemically prior to sintering and/or after sintering, in particular using the previously described techniques. Filters manufactured in this manner may likewise be used in, for example, blood filtering apparatus or cell separation in general.

In typical embodiments of the fabrication process a thin (e.g., 2-3 μm) skin is left over the second surface. Where present this can be removed, before or after sintering, by processes as described above to fabricate the filter structure. Alternatively it may be left in place to enable the fabrication of a set of flared wells of controllable aperture.

Thus we also described a ceramic plate having a structure comprising first and second surfaces and an arrangement of flared passageways extending between and connecting with one of said first and second surfaces to define a set of flared wells. There is further provided a method of manufacturing such a plate.

In principle the filter structure may have applications other than filtering. For example one or both surfaces may be patterned, for example by selective abrasion, and the patterned structure may be used to as a mask for visible or non-visible light. Such selective abrasion may be performed, for example, by a CNC router. A mask of this type may be used, for example, to display a logo or potentially, with a smaller scale pattern, as a mask to photolithography.

Thus we further described a method of manufacturing a ceramic plate having a controlled channel opening size, more particularly a method of manufacturing a mask, the method comprising: fabricating a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said flared pore contains polymer material and regions between said flared pores comprise ceramic material; and sintering said ceramic precursor element to fuse said ceramic material and remove said polymer material; the method further comprising removing a controlled thickness portion of said first surface to open said flared pores to said controlled channel opening size.

We also described a plate/mask structure comprising first and second surfaces and an arrangement of flared passageways extending between and connecting with said first and second surfaces, optionally wherein the arrangement of flared passageways of the plate/mask structure is patterned.

In embodiments of the above described manufacturing methods/filters/plates/structures a surface of the filter may be treated to modify a physical, chemical or biological characteristic of the surface, in particular to provide the filter with a surface coating. For example the surface may be plasma treated, say to render the surface hydrophilic or hydrophobic, and/or the surface may be treated with a molecular material to functionalise the surface. In embodiments a surface of the filter is coated to modify the filtration characteristics, in particular to more effectively select or filter out one or more targets.

We also described a method of filtering particles from a fluid (liquid or gas) using a filter as described above/as manufactured by an above-described method.

### Ceramic Filter Fabrication Apparatus and Methods

It is desirable to be able to automate the manufacture of filters according to the techniques that we have previously described.

According to the present invention there is therefore provided an apparatus for controlling a thickness of a workpiece element, the apparatus comprising: a lapping machine having a lapping plate; and a holder to hold a workpiece element; wherein said holder comprises: a workpiece element mount to mount a workpiece element to be lapped such that a surface of said workpiece element lies substantially flush with a lower face of said holder; an adjustable actuator to controllably move said surface of said workpiece element so that it remains substantially flush or projects beyond said lower face of said holder during lapping; means for urging said holder towards said lapping plate; and a sensor for sensing a displacement of the workpiece element towards said lapping plate.

Embodiments of the apparatus provide the ability to hold a thin disc of hard ceramic in such a way that a very thin, but controllable thickness surface layer can be lapped (abraded).

In some preferred embodiments the workpiece element mount comprises an adjustable piston controlled by the actuator, which may comprise a micrometer screw thread.

Preferably a seal is included between the piston and the holder. In embodiments the lower face of the holder includes a ceramic portion (wear portion) extending around a perimeter of the workpiece element, when the workpiece element is mounted.

In embodiments the means for urging the holder towards the lapping plate comprises one or more weights mounted on the holder. In preferred embodiments movement control means is provided, for example in the form of a stop for the actuator, to control a degree of abrasion of the workpiece element.

The workpiece element mount may be arranged to mount a plurality of workpiece elements to be lapped.

In embodiments, the apparatus may further comprise a system controller arranged to receive a sensor signal output by the sensor, the sensor signal indicative of the displacement of the workpiece element towards the lapping plate.

The system controller may be arranged to control the lapping machine based on the sensed displacement of the workpiece element towards the lapping plate.

In particular, the system controller may be arranged to control the rotational speed of said lapping plate based on the sensed displacement of the workpiece element towards the lapping plate. The system controller may be arranged to transmit a control signal to the lapping machine to stop rotation of the lapping plate upon detection that the sensed displacement has reached a target displacement.

The system controller may be arranged to control the adjustable actuator based on the sensed displacement of the workpiece element towards the lapping plate.

The system controller may be arranged to reduce a pressure exerted on the workpiece element by the adjustable actuator upon detection that the sensed displacement of the workpiece element towards said lapping plate is greater than one or more threshold displacement values.

The sensor may take various forms. The sensor may comprise a spring and a transducer which detects displacement of the spring to sense the displacement of the workpiece element towards said lapping plate. The lapping plate may comprise a conductive material and the sensor may be a capacitance sensor configured to measure a change in capacitance between the sensor and the conductive material to sense the displacement of the workpiece element towards said lapping plate. Alternatively or additionally, the sensor may be a linear variable differential transformer.

Alternatively or additionally, the sensor may be an ultrasonic sensor and/or a photoelectric sensor.

In embodiments, the apparatus may further comprise an abrasive fluid dispensing unit configured to dispense an abrasive fluid between the lapping plate and the workpiece element, and the holder may further comprise a humidity sensor and a flow rate of the dispensed abrasive fluid is controlled in dependence on a humidity sensor signal output by said humidity sensor.

In the context of the workpiece element being a filter element, the filter element may be ground and measured to establish average channel opening size, in particular to achieve a desired average (mean, median or mode) filter channel opening at the narrow end of a flared channel where it opens onto the surface of the filter element. (The filter channel opening size described is also referred to herein as pore size). The average filter channel opening size may be determined by measuring the maximum or minimum lateral dimension across the openings of a plurality of channels and taking the mean, median or mode of these measurements.

In embodiments the apparatus may include an associated computer system to output a target filter thickness or abrasion length (amount of material to abrade) given a target average channel opening size to be achieved. This computer system may comprise, for example, a suitably programmed, dedicated or general purpose computer with one or more user and/or machine interfaces. In embodiments the computer system may comprise a programmable logic controller (PLC). The computer system may implement a model relating filter thickness l or a change in filter thickness (abraded distance) Δl to average channel opening size d or to a change in channel opening size Δd. This model may be determined by calibration (the computer system then storing calibration data defining a relationship established between d or Δd and I or Δl), or a mathematical model linking d or Δd and I or Δl may be used, as described later.

Optionally such a computer system may include a control system to control the abrasion of the filter element, in particular to achieve a desired average (mean, median or mode) filter channel opening at the narrow end of a flared channel where it opens onto the surface of the filter element. The control system may receive an input defining (measuring) a thickness of the filter plate and/or a degree of abrasion of the filter plate. This measurement may be made automatically, by the apparatus, or may be manually input. The control system may provide a control output for controlling the apparatus, for example an indicator such as a visual or audible warning to cease abrasion, or a control signal to control (stop) the lapping machine.

In embodiments, therefore, the system controller is configured to sense or measure one or more parameters of the apparatus when used to abrade the workpiece element, in particular one or more of: a pressure of the workpiece element on the lapping plate, a rotational speed of the lapping plate, and a duration of lapping of the workpiece element. The system controller may then control one or more of these parameters to control the thickness of the workpiece element. In embodiments, in the context of the workpiece element being a filter element therefore, the system controller includes a stored model relating the one or more sensed parameters to the filter channel opening size. As previously described such a stored model may comprise a mathematical model and/or an empirical model.

The invention further provides a method of manufacturing a work product using apparatus as described above to controllably remove a portion of the thickness of a surface of a workpiece element to thereby control a thickness of the work product.

In the context of the workpiece element being a ceramic filter element, it will be appreciated that when employing apparatus of the type described above it is important that the ceramic filter element is substantially flat. However because of the presence of flared pores in the ceramic precursor element, when this element is sintered it tends to warp because of the stresses involved. More particularly the surface with the wide pore ends tends to stretch more than the surface with the small pore ends, so that the ceramic precursor element becomes convex on the surface on which the large pore ends terminate and concave on the surface on which the small pore ends terminate. If the ceramic precursor element is laid flat, with the large pore ends on the bottom surface, the edges of the ceramic precursor element tend to bend upwards during sintering.

Therefore, a force may be applied to the ceramic precursor element during sintering, with a component in a direction from the apex towards the base of the flared pores.

When used with grinding/lapping apparatus as described above this technique can be employed to maintain the ceramic precursor element substantially flat during sintering. However applications of this technique are not limited to use with apparatus as described above.

We also describe a method of manufacturing a ceramic filter having a controlled filter channel opening size, the method comprising: sintering a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex, wherein said sintering comprises applying a force to said ceramic precursor element during said sintering, wherein said force has a component in a direction from said apex towards said base of said flared pore; and fabricating said ceramic filter by removing a controlled thickness portion of said flat surface to open said flared pores to said controlled filter channel opening size.

One difficulty with this technique is that typically the sintering temperature is high, for example around 1400-1450° C. (the temperature at which aluminium oxide begins to fuse). If a force is to be applied by, for example, a flat plate then this should be of a material which is still sufficiently stiff at the sintering temperature that the ceramic precursor element remains substantially flat during sintering. In practice it has been found that this can be achieved by using a ceramic material such as aluminium neosilicate, forming the material into a brick so that the weight of the material applies the force keeping the ceramic precursor element flat during sintering. In principle sufficient force can be applied in this way by stacking a number of ceramic precursor elements on top of one another, but in other approaches an ‘andalusite brick’ is employed, as well as aluminium oxide-based slabs. The ceramic precursor elements may rest on the base of the sintering furnace which may be, for example, a flat base of alumina.

Although the above described techniques are particularly useful in providing flat ceramic filter elements, in principle similar techniques may be employed to form ceramic filter elements of other shapes. Thus in other applications fabricating a ceramic filter element may include shaping the ceramic filter element by applying force to sandwich the ceramic precursor element within a former defining the desired, target shape. Again the former may be constructed of a suitable refractory material, such as a ceramic material.

Preferably, the ceramic filter element manufacture uses the techniques described above under the heading ‘ceramic filters’. In particular the ceramic precursor element is preferably fabricated by forming a dope comprising the ceramic material, a polymer, and a solvent for the polymer. This dope may then be formed into the desired shape for the ceramic precursor. Typically the dope comprises a viscous liquid and it may therefore be formed by casting into the desired shape, which may be a flat slab. The formed shape may then be treated in a bath of liquid, such as water, to at least partially replace the solvent with the liquid of the bath. It has been found that the quality of the ceramic precursor element, and hence of the manufactured ceramic filter, can be improved by degassing the dope preferably (but not essentially) prior to forming (typically casting) the dope into the desired shape. Such degassing may be performed, for example, in a vacuum chamber or by centrifugation. This procedure tends to reduce the number of minute air bubbles, thus increasing the integrity of the filter element and improving the manufacture of a defect-free filter.

As described above, in preferred embodiments the ceramic precursor element is sintered prior to grinding/lapping. However in principle the grinding/lapping may be performed prior to sintering, although this is generally less preferable as unless performed carefully the pores tend to deform.

### BRIEF DESCRIPTION OF THE DRAWINGS

These and other aspects of the invention will now be further described, by way of example only, with reference to the accompanying figures in which:

FIGS. 1A and 1B show, schematically, a principle of pore size control in a method of manufacturing a ceramic filter according to an embodiment of the invention, and schematic views from the top and bottom of an embodiment of a filter manufactured in this way;

FIGS. 2A and 2B show, respectively fabrication of a fibre precursor element and fabrication of a membrane/wafer precursor element;

FIG. 3 shows, schematically, a vertical cross-section through a water bath-treated membrane precursor element;

FIG. 4 illustrates an example of a controlled height cutter which may be employed for removing a layer from the ceramic precursor element;

FIG. 5 illustrates a circular ceramic element, and use of a diamond polisher to abrade a sintered ceramic element;

FIG. 6 illustrates, schematically, blood filtering using a ceramic filter according to an embodiment of the invention;

FIG. 7 shows a range of particle separations of embodiments of membrane filters according to the invention (labelled “microfiltration”), alongside other separation principles for different particle sizes;

FIG. 8 shows an image of a top view of a ceramic filter according to an embodiment of the invention under the microscope (magnification of 100×), and a schematic illustration of a diagonal cut across the top of the filter that was employed to provide pores with different opening dimensions along the length of the membrane surface shown;

FIG. 9 shows a set of images, a through e, of functional filters manufactured using a method according to an embodiment of the invention, showing: image a) a cross-sectional view of a membrane (microscope magnification of 100×); image b) a top view of a membrane after abrasion of the top surface (microscope magnification of 100×); image c) a top view of the membrane in image b after further abrasion of the top surface (microscope magnification of 100×); image d) a bottom view of a membrane after abrasion of the bottom surface (microscope magnification of 100×); and image e) a perspective view of the top of a membrane filter as prepared according to the described method (disc diameter 50 mm);

FIGS. 10A and 10B show cross-sections through apparatus for a thickness of a workpiece element according to embodiments of the invention;

FIGS. 11A and 11B show an enlargement of a workpiece element region of FIG. 10 illustrating, in FIG. 11A, a workpiece element which fits the holder and in FIG. 11B a holder for a reduced sized workpiece element;

FIG. 12 illustrates a prototype holder; and

FIGS. 13A and 13B represent possible sensor arrangements to measure the displacement of a workpiece towards a lapping plate of a lapping machine (which can be correlated to the amount of surface material removed from the same). In FIG. 13A, a sensor is used to measure directly the displacement; in FIG. 13B, the sensor is placed away from the lapping plate.

### DETAILED DESCRIPTION OF PREFERRED EMBODIMENTS

### Ceramic Filters

Techniques to produce ceramic materials out of sol-gel casting include making a dope solution, composed of a binder (or dispersant), a solvent wherein said binder is soluble and a ceramic material in crystal form (such as, but not limited to, aluminium oxide, zirconia oxide, and the like). If dipped into a non-solvent such as water these can produce highly organised internal pores. We employ modified such structures for the microfiltration of particles in the micrometer range (0.1 μm-100 μm). Advantages of the filters include robustness due to the stable materials used, low price, and a simple manufacturing process. Applications include treatment of fermentation broths and solvent extracts, processing of alginates, pyrogen and bacteria removal, production of antibiotics and others, for example in situations where high temperatures and/or high pressures and/or acidic or basic conditions are present. We will also describe their use for blood filtration. In particular we will describe techniques for producing on-demand pore sizes on the membrane, to allow it to be tailored for a particular microfiltration application.

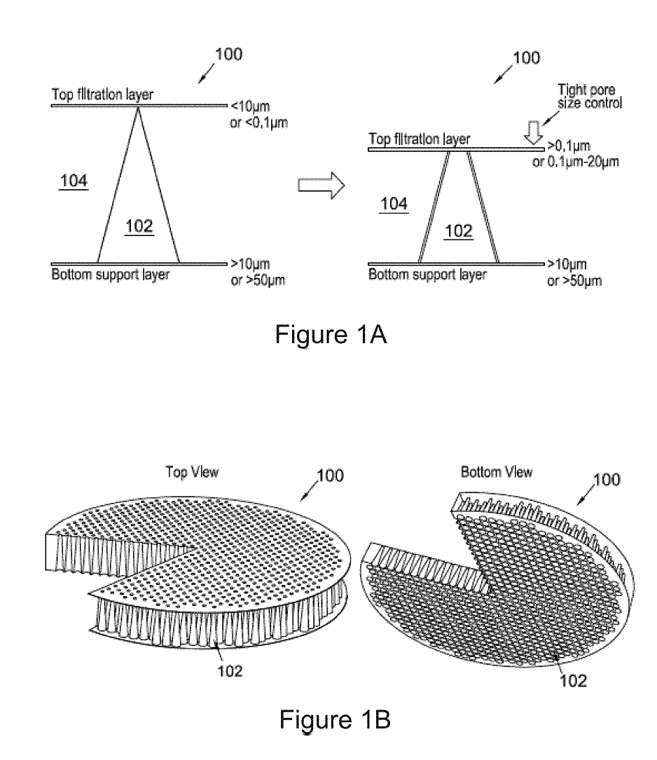

The ceramic membrane filters 100 that are obtained by embodiments of the techniques we describe are composed of conical shaped pores 102, as illustrated in FIG. 1, that cross through these membranes 104, top to bottom. With this pore geometry the production of membranes 104 of different pore size distributions can be achieved by producing membranes 104 in large batches (which reduces the manufacturing costs), afterwards tailoring the pores 102 for an intended application—i.e. with variable pore sizes. Such a method allows a reduction in the time and cost requirements to develop a tailor-made filter—by changing e.g. the dope solution ratios, the type of non-solvent, the temperature of the sintering process, the drying time of the membrane film 104, the thickness of the filter 100 and so forth, one can change the pore angle/packing density and other filter parameters.

Thus we describe the manufacture of tailor-made pore sizes in ceramic filters 100, allowing their use in a wide range of applications in the field of microfiltration, particularly in filtration of cells.

Initially a dope solution is prepared with a mixture of a solvent, a ceramic-based material, and a polymer.

The solvent may be, but is not limited to: dimethylformamide, dimethylsulfoxide, dimethylformamide, dimethylacetamide, N-methyl-2-pyrrolidone, hexamethylphosphoramide, dioxane, others derived therefrom or other organic solvents available that can dissolve the polymer.

The ceramic-based material may be, but is not limited to: aluminum oxide, titanium oxide, zirconium oxide, silicon carbide, glassy materials, or any other similar materials, optionally surface-treated with cross-linking agents.

The polymer material may be, but is not limited to: polyamide, poly (caprolactone), polyurethane, poly (L-lactic-co-glycolic acid), polyacrylonitrile, polyimide, poly (methylmethacrylate), poly (D, L-lactate), polystyrene, polyether ether ketone, polyethersulphone, polyvinylidene fluoride, polysulfone, polyethersulfone or any other similar material, preferably surface-treated with cross-linking agents. The polymer acts as a water-insoluble binder in the dope; it should be burnt away at sintering temperatures (600-1500° C.).

Optionally a dispersing agent/surfactant can be added to the mixture. The dispersing agent may be, but is not limited to: alkylbenzenesulfonates, lignin sulfonates, fatty alcoholethoxylates, alkylphenol ethoxylates, PEG 30 dipolyhydroxystearate, sodium stearate, 4-(5-Dodecyl) benzenesulfonate, sodium dodecyl sulphate, cetrimonium bromide, fluorosurfactants, siloxane surfactants, alkyl ethers, block copolymers of polyethylene glycol and polypropylene glycol, others derived therein, and/or any other amphiphilic compound.

In an example embodiment the solvent is dimethylsulfoxide, the ceramic is aluminum oxide, the polymer is polyethersulphone, and the dispersing agent is PEG 30 dipolyhydroxystearate.

The dope solution is then degassed using a vacuum chamber and casted to a smooth surface, using a casting knife or other method to control the thickness of the casted coating. The shape of the cast dope solution may hereby be adjusted according to the desired shape of the ceramic precursor element to be fabricated. The cast dope solution is then immediately transferred into a water bath and left standing there for a period longer than 5 minutes, typically overnight, to set. During this process the solvent is gradually replaced by the water, surface tension effects at the surface, and convection, resulting in the development of a substantially regular pattern of conical void regions. The polymer and/or the polymer/ceramic material mixture are not substantially dissolved in the water bath. The film is then removed from water and allowed to dry for a period longer than 5 minutes, e.g. 24 hours.

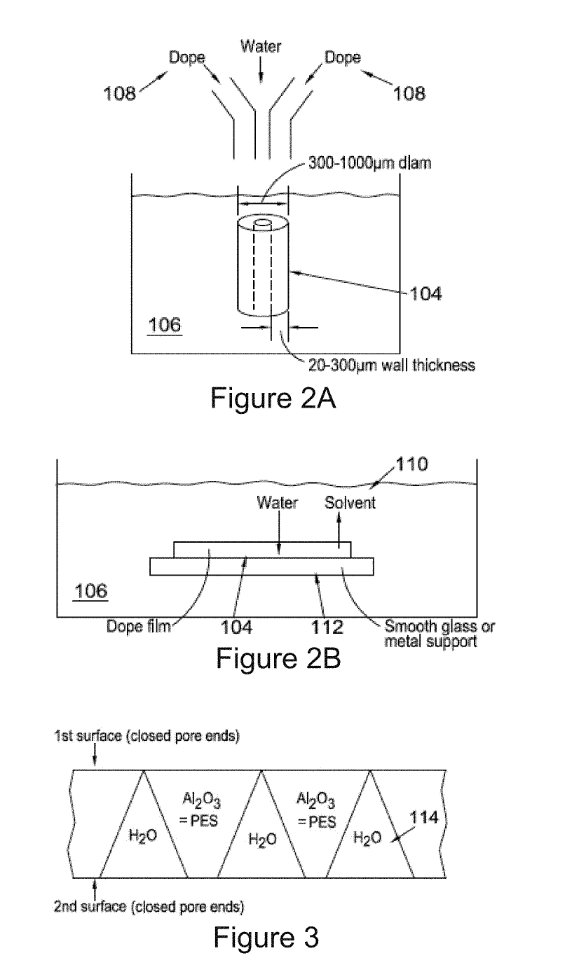

FIG. 2A illustrates a tubular precursor membrane 104 in a water bath 106; FIG. 2B illustrates a process of forming a tubular precursor element 104. FIG. 3 illustrates a cross-section of the membrane 104 of FIGS. 2A and 2B after treatment in the water bath—the PES is burnt away during sintering. Typically the membrane may be of order of 50 μm (FIG. 2A) and 500 μm (FIG. 2B) thickness.

In more detail, as shown in FIG. 2A, the dope solution 108 which comprises the ceramic-based material, the polymer and the solvent is placed into a water bath 106. In this example, the precursor element 104 has a tubular shape with a diameter of 300-1000 μm and a wall thickness of 20-30 μm. It will be appreciated that the precursor element 104 may be of any shape, which may be determined by the particular use of the ceramic membrane filter 100.

FIG. 2B shows an example in which the precursor element 104 has a tabular shape. The precursor element 104 may be prepared on a smooth metal layer 112 which allows for a smooth precursor element 104 to be formed thereon. As illustrated in FIG. 2B, the metal layer 112 may be replaced with a smooth glass or other suitable support which allows for preparing a smooth precursor element 104.

It can be seen that when the precursor element 104 is placed into the water bath 106, water penetrates into the precursor element 104 and replaces the solvent 110 which is released into the water bath 106. As outlined above, the precursor element 104 may be placed in the water bath 106 for a period longer than 5 minutes.

FIG. 3 shows a cross-sectional view of the precursor element 104 prepared as illustrated in FIG. 2B. The regions between the flared pores 102 comprise a mixture of ceramic and polymeric material. The inventors have recently observed that the pores 102 are not filled with polymer, but are in fact void. It can be seen that in the area where pores 102 are to be fabricated, water 114 firstly fills those voids.

In order to partly remove the water 114 from the precursor element 104, the film is first removed from the water bath 106 and then left to dry for a pre-determined amount of time. Afterwards, the polymer may be burnt away by sintering at a pre-determined temperature, in this example between 500-1500° C.

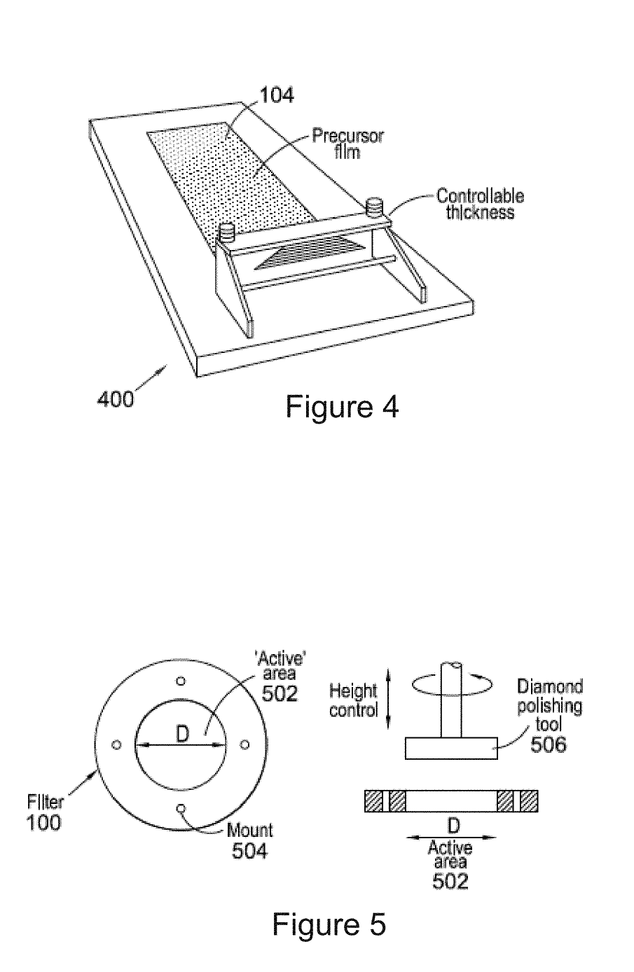

After forming the precursor element 104, a tool 400, such as a casting knife or other similar device (FIG. 4), is used to remove the top layer of the membrane film 104, by scrapping the surface and removing a thickness between 0 μm and the final thickness of the film 104. The thickness of the layer of the film 104 to be scraped off is controllable by the tool 400 used for scrapping. This procedure can also be accomplished by pouring a solvent (from the list described above) on top of the membrane film and allow it to stand on top of the membrane film for a period, typically longer than 1 second, or shaking it to accelerate the process, scrapping the surface of the membrane to clean using the same method described above and immediately proceeding to sintering of the film.

The film is then cut into the desired shape of the filter, for example a circle, as shown in FIG. 5. This may be done using a circular knife. The membrane is then sintered, for example at a temperature above 500 degrees Celsius for a period of the order of two hours, followed by at least 1 hour (for example 3-4 hours) at 1200-1600 degrees Celsius. Afterwards, the membrane filter is optionally further processed by abrading the surface of the membrane, to render its pores larger according to the time, pressure and abrading material used. FIG. 5 shows polishing of the central, active region 502 of a filter 100, held in place by mounts 504 at the edge. In this example, a diamond polishing tool 506 is placed on the top of the central, active region 502 of the filter 100.

The diamond polishing tool 506 has the shape of a circular disc, and is rotated around its own axis as illustrated to abrade the surface of the filter 100 in the active region 502. The skilled person will appreciate that the pressure exerted onto the active region 502 via tool 506, the roughness and abrasiveness of the diamond polishing tool 506, the spinning speed, and other parameters may determine the abrading rate. It will be appreciated that the diamond polisher may be replaced with another suitable material for abrading the active region 502. The diamond polishing tool 506 may be controllable in a vertical direction as shown in FIG. 5 in order to define the amount of material on the active region 502 to be abraded.

Thus, two main options are available to control the pore sizes: process 1) after casting of the membrane film 104 and before sintering of the film 104; and process 2) after sintering of the film 104, having attained the ceramic filter 100. Both processes can be undertaken either alone or combined, in order to give a filter 100 a desired pore size specification.

Process 1, before sintering, may be achieved by removing a top layer of the cast membrane 104, removing a thickness of between 0 μm and the final thickness of the dried film 104, before or after drying. This may be performed by placing a solvent on top of the membrane 104, allowing it to rest there for a period, typically longer than 1 second, or shaking it to accelerate the process, then scrapping the surface of the membrane 104 to clean using a tool 400, such as a casting knife or other similar and then evaporating the solvent by immediately transferring the film 104 into a hot oven. The longer the exposure of the membrane 104 to the solvent, the larger the pores 102 produced. Another method which can be used in process 1 is to use a tool 400, such as a casting knife or other similar, to remove the top layer of the membrane (the thicker the gap of the tool 400 used, the smaller the pore sizes in the resulting filter 100), or by using a soft tool to gently scrap the surface of the film 104 (depending on the strength and/or the time during which this is done will produce membranes 104 with controllable pore sizes).

Process 2, which may be used in addition to process 1 or on its own, is performed after sintering and can achieve better tuneable control of the pore sizes. This is achieved by abrading the surface of the membrane 104, to render its pores 102 larger depending on the time, pressure and abrading material used (e.g. “sandpaper” or a diamond tool).

Using this method, the pore size at the surface of the membrane 104 can be tightly controlled, depending on the process(es) used, the perpendicular force exerted over the membrane film 104, and the material(s) used. This facilitates a one-step universal manufacture process of a base comprising a ceramic membrane disc, which can then be tailored for different applications, following process(es) 1 and/or 2.

As it can be seen from FIG. 1, in a pore 102 with conical geometry seen transversally and in 2 dimensions, by changing the amount of abrasion at the smaller-pore size end it is possible to create pores 102 with a controlled, variable size.

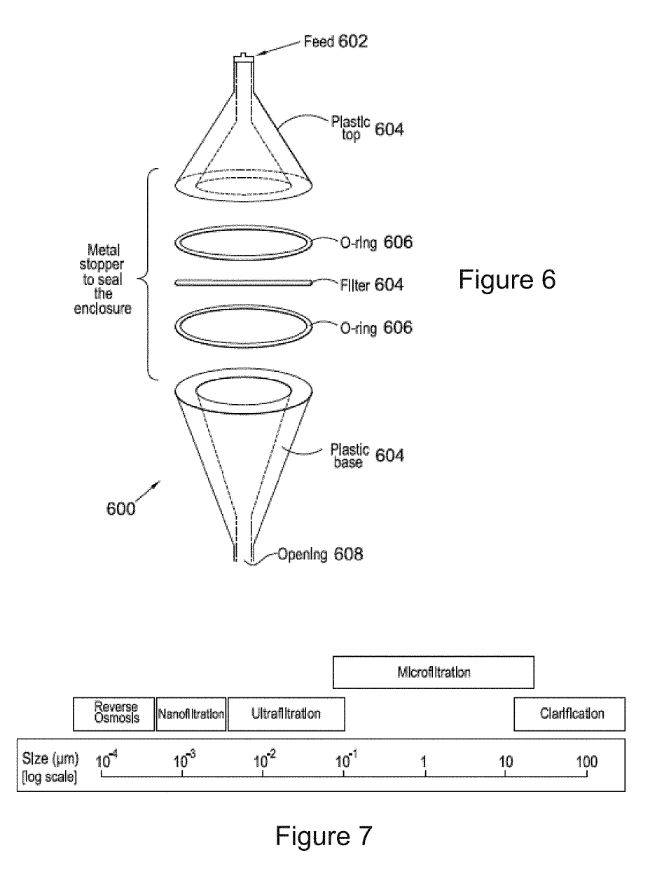

Filters 100 fabricated by these techniques are useful for membrane filtration for the industrial separation of blood cells to eliminate leukocytes (to reduce the risk of infection). Membrane filtration is simple and inexpensive and it is easy to maintain sterility during the process. An example schematic illustration of such blood filtering apparatus 600 is shown in FIG. 6.

As shown in FIG. 6, the filter 100 is sandwiched between a plastic top 604 and a plastic base 610. Two seals (O-rings) 606 are provided, between the filter 100 and the plastic top 604 and plastic base 610, respectively. The plastic top 604 comprises a feed 602 through which the material to be filtered by filter 100 may be inserted into apparatus 600. The plastic base 610 comprises an opening 608 through which the filtered material may then be collected. The assembly may be held together by a metal strap.

FIG. 7 shows a range of particle separations of embodiments of membrane filters. It can be seen that a range of filters comprising pores with a broad range of sizes (in this example ˜0.1 μm to a few tens of μm) may be fabricated using techniques described herein. It will be understood that the size of the pores may be determined by the size of the specific material(s) to be filtered.

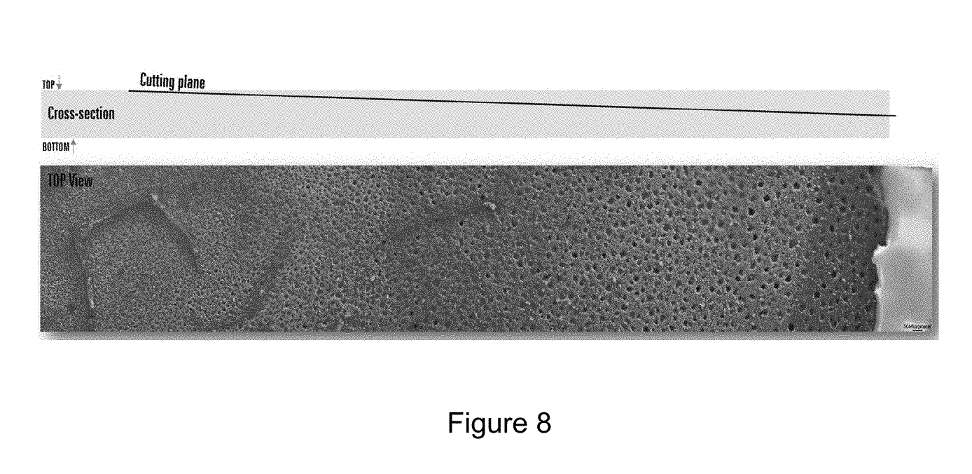

FIG. 8 shows a top-view of a ceramic filter prepared using techniques as described herein. As illustrated in the schematic cross-sectional view, the filter is cut such that the cut is deeper towards the right-hand side of the filter. As can be seen, the depth of the cut determines the opening size of the pores.

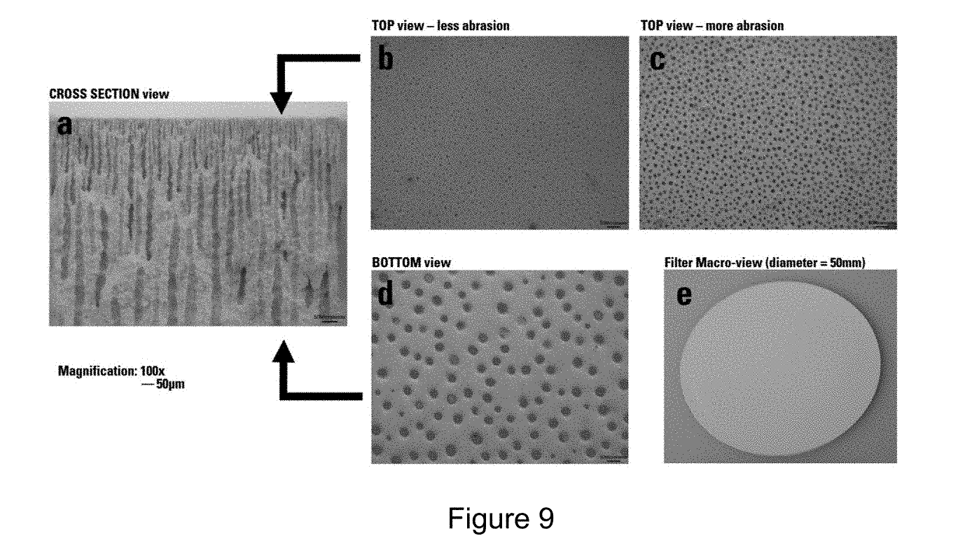

At FIG. 9, image a shows a cross-sectional view of the filter. It can be seen that the diameter of the pores increases towards the bottom of the membrane filter. Images b and c show top-views of the filter illustrated in image a. As already illustrated in FIG. 8, the diameter of the opening of the pores at the top surface of the filter is determined by the depth of abrasion of the top surface of the membrane. Image d shows a bottom-view of the filter. The opening of the pores is larger in diameter as described above.

Image e shows a perspective view of the top of a membrane filter with a diameter of, in this example, 50 mm. As described above, the shape of the membrane filter may be adjusted according to the specific implementation of the filter.

More generally ceramic filters are useful in harsh environmental conditions (chemical/thermal/pH), and also when high pressures are required during the separation process or afterwards (for example for regenerating a membrane).

Such harsh conditions are not generally present when filtering human cells but the high strength of ceramic filters confers an important advantage in this application by facilitating the creation of a more densely packed pore structure. This in turn helps to maintain the shape and viability of filtered cells by reducing the stresses arising from the passage of the cells through the filter.

### Ceramic Filter Fabrication Apparatus and Methods

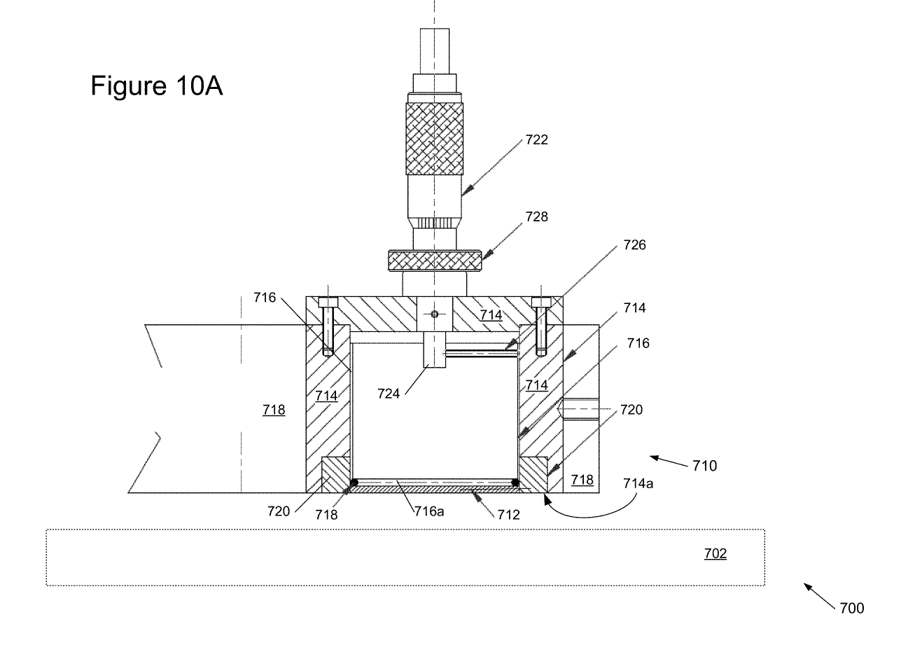

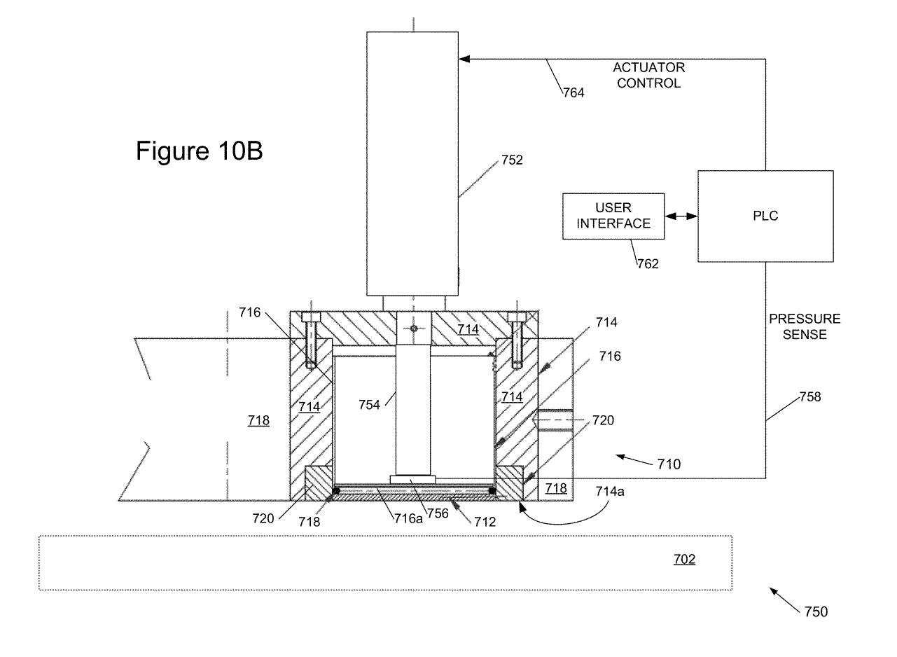

Referring now to FIG. 10A, this shows a cross-sectional view of an embodiment of apparatus 700 for controlling a thickness of a workpiece element (e.g. controlling the filter channel opening size of a ceramic filter element as previously described). The apparatus comprises a lapping machine (not shown) including a lapping plate 702, shown dashed, on top of which sits a holder 710 to hold a workpiece element such as a ceramic filter element 712 as previously described. In some preferred applications the ceramic disc 712 is lapped (ground) after sintering, but in principle the apparatus may also be employed to lap the precursor filter element prior to sintering, although in this case a much less aggressive abrasive agent should be employed.

The holder 710 comprises a workpiece element mount (or housing) 714, for example of stainless steel, housing a piston 716, for example of hard steel or ceramic, having a flat face 716a against which the ceramic disc 712 bears. A seal 718, for example an ‘O’ ring, is preferably included between the piston and housing/mount to resist the ingress of abrasive grit and the like from the lapping process.

In some preferred embodiments the holder includes a mounting 718 for one or more weights to provide a downward force to urge the ceramic disc 712 against the lapping plate 702, including the use of linear actuator(s). However the skilled person will appreciate that a suitable force may be applied in other ways. In preferred embodiments a lower surface 714a of the workpiece element mount 714 is provided with a ceramic portion 720 extending around an inner perimeter of the mount adjacent ceramic disc 712, intended to wear in a similar manner to disc 712.

The piston 716 is connected to a micrometer screw 722 which controls the linear movement of a (non-rotating) actuator 724, connected by a mechanical coupling 726 to the piston 716. In use the micrometer screw 722 controls movement of the piston, to urge the ceramic disc 712 downwards so that it is substantially flush with the lower face 714a of the filter holder (but projecting slightly). As the lower surface of ceramic disc 712 is gradually ground away the micrometer screw is controlled to move the ceramic disc downwards for further abrasion. In some embodiments this movement may be computer controlled. Additionally or alternatively a mechanical stop 728, such as a lock nut, may be provided on the actuator 724 to define a linear distance of movement of the ceramic disc and hence an average pore size opening.

In some embodiments the pore size opening may be controlled by establishing a calibration curve between the amount (thickness) of material to be removed and the average pore size (for example average maximum or minimum dimension measured across the opening at the surface of the ceramic disc). Alternatively a simple mathematical model may be employed in which the taper of a pore is modelled as a linear taper, in which case the purported pore opening dimension may be determined by trigonometry—if θ is the angle the wall of a pore makes to a normal to the surface of the disc 712, a change in pore opening is twice (two flared walls) the abraded thickness times the tangent of angle θ Thus for a change in filter thickness (abraded distance) Δl, the change in channel opening size Δd may be estimated from Δd=2Δl tan θ.

In some preferred embodiments of the apparatus 700 a pressure sensor is included to monitor and/or control the degree of applied force, and hence the rate of abrasion of the ceramic filter plate. Additionally or alternatively this or another pressure sensor may be employed to detect an operational or fault condition of the apparatus such as binding between the lapping plate and the filter plate, exhaustion of the abrasive material, or the like.

FIG. 10B shows a cross-sectional view of a further embodiment of apparatus 750 for automatically controlling a thickness of a workpiece element (e.g. controlling the filter channel opening size of a ceramic filter element). Like elements to those previously described are indicated by like reference numerals.

In apparatus 750 a linear actuator 752 controls the linear motion of an actuator 754 which bears upon a version of piston 716 via a pressure sensor 756. A pressure sensor 756 measures the force or pressure, exerted on the workpiece element (e.g. a ceramic filter element), urging the workpiece element towards the lapping plate 702. The skilled person will appreciate that in other arrangements pressure sensor 756 may be located elsewhere, for example in a mount of the linear actuator on housing 714 or within the linear actuator itself.

The pressure sensor 756 provides an output 758, in embodiments a digital output, to a system controller 760 which may be a PLC (programmable logic controller). The controller 760, in embodiments, has a user interface 762, for example for setting a target average filter channel opening size and, preferably, one or more control outputs 764. In embodiments a control output 764 is provided to the linear actuator 752 to control the linear motion of the ceramic filter element downwards onto the lapping plate during the abrasion process, for example to achieve a target pressure or pressure range, for example over the duration of a target time interval corresponding to a target filter channel opening size or size range.

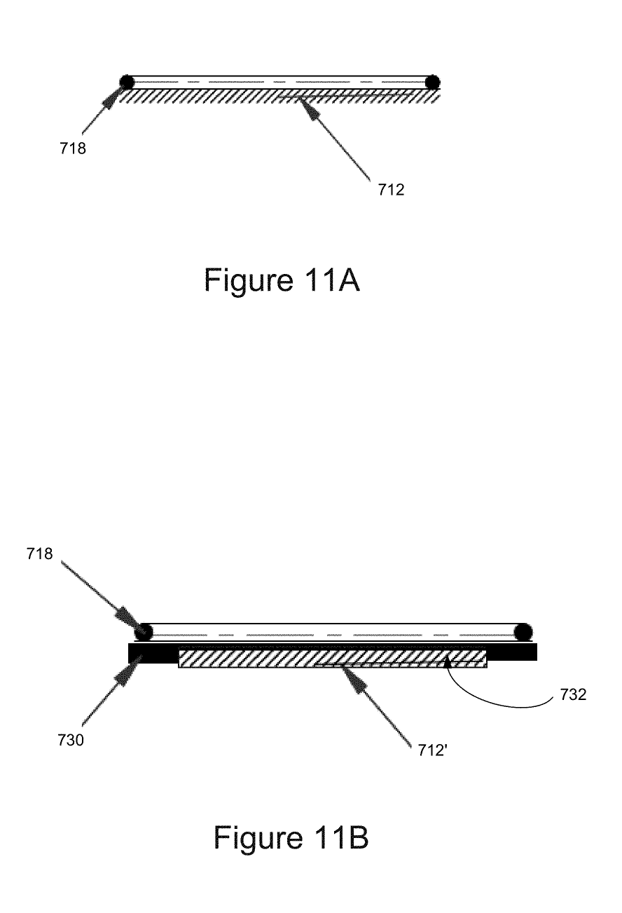

Referring next to FIG. 11A, shown is an enlargement of FIG. 10 in which the ceramic disc fits the filter mount. In embodiments the mount is designed for a first, standard sized disc, for example 55 mm in diameter. FIG. 11B shows a corresponding portion of the apparatus of FIG. 10 used with a reduced size ceramic disc 712′, for example of 50 mm or less. In this latter case a holder 730 is employed, the holder 730 having dimensions matching the size of a standard ceramic disc 712 and having a recessed portion 732 for mounting the reduced size disc. In some preferred embodiments the thickness of the holder 730 is less than 400 μm.

It is important for the apparatus 700/750 that the ceramic filter element is substantially flat. However the flared pores can cause the precursor element to warp during sintering. Preferably, therefore, a force is applied to the ceramic precursor element during sintering with a component in a direction from the apex towards the base of the flared pores, for example by weighting or clamping the precursor element during sintering. The weight or clamp should use a material which is sufficiently stiff at the sintering temperature, which may be of order 1500° C., that the precursor is maintained flat; thus another ceramic material may be employed.

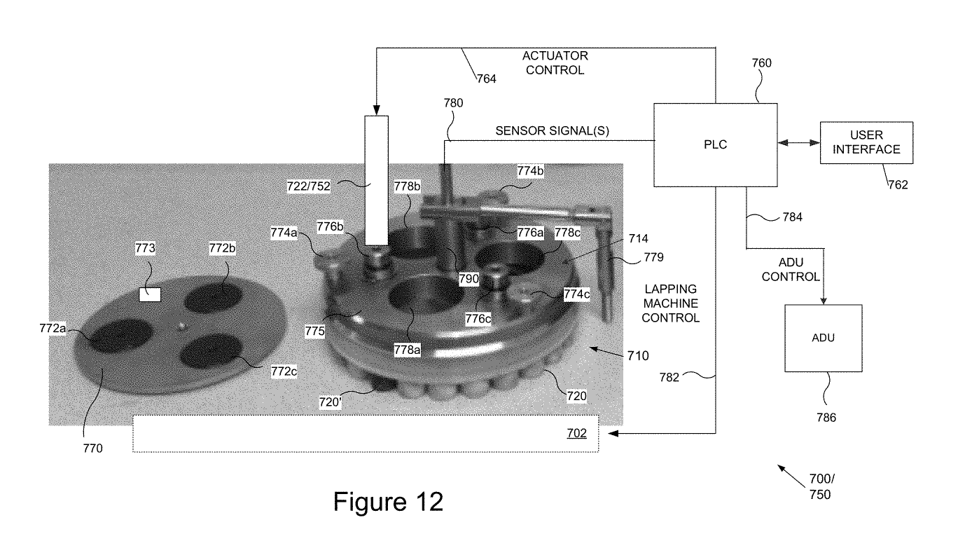

FIG. 12 illustrates a prototype holder 710 built by the inventors for use in apparatus 700/750 described above. It will be appreciated that the form of the prototype holder 710 shown in FIG. 12 is merely exemplary.

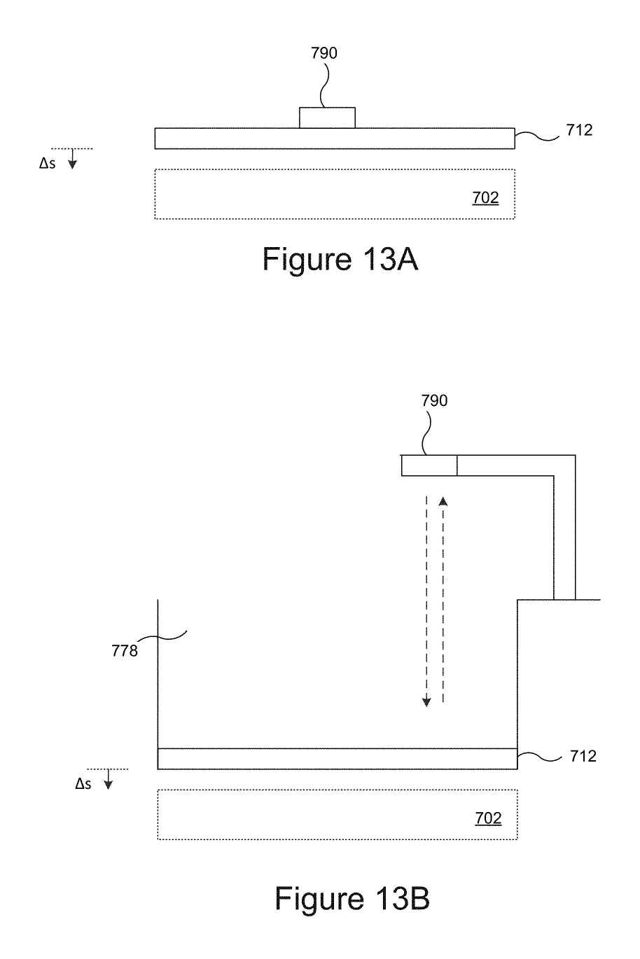

FIGS. 13A and 13B show a sensor 790 of the holder 710 which is configured to sense a displacement of a workpiece element 712 towards the lapping plate 702.

Reference will be made to FIGS. 12, 13A and 13B to explain how in embodiments of the invention the amount of lapping can be controlled based on material removal from the workpiece element 712 rather than time elapsed (as currently done in the industry).

Whilst FIGS. 10A and 10B have been described above with reference to controlling a thickness of a single workpiece element, as shown in FIG. 12 the workpiece element mount 714 may be arranged to mount a plurality of workpiece elements to be lapped. The example holder 710 shown in FIG. 12 illustrates a workpiece element mount 714 that is arranged to mount three workpiece elements to be lapped, however this is merely an example.

In this regard, the holder 710 comprises a holder insert 770 which comprises portions 772a, 772b, and 772c which are sized so as to retain the workpiece elements 712. The holder insert 770 may be made of stainless steel (or any other suitable material that will be apparent to persons skilled in the art). If necessary a filter holder 730 described above with reference to FIG. 11B may be placed into one or more of the portions 772a-c to retain reduced sized workpiece elements.

The holder insert 770 is sized so as to fit inside the holder 710. A lower surface (not shown in FIG. 12) of the holder insert 770 may be provided with a plurality of ceramic legs for stability which in operation come into contact with the rotating lapping plate 702. Screws 774 (or any other type of fixing means) are removable to allow the insert 770 to be placed into the holder 710.

One or more actuator connectors 776a-c may be provided on an upper surface 775 of the holder 710. Each actuator connectors 776a-c is formed so as to connect to an actuator 722/752 that has been previously described above.

Whilst only a single actuator is shown in FIG. 12 for reasons of clarity, it will be appreciated that further actuators (not shown in FIG. 12) may be connected to actuator connector 776b and actuator connector 776c respectively.

In the example shown in FIG. 12 the actuator(s) 722/752 control movement of piston(s) 716 to urge the workpiece elements 712 downwards so that they are substantially flush with the lower face 714a of the holder 710. In one example arrangement the piston(s) 716 come into contact with an upper surface of the holder insert 770 (for example against portions of the upper surface of the holder insert 770 positioned between the portions 772a-c). In an alternative example arrangement the piston(s) 716 come into contact with the upper surfaces of the workpiece element(s) 712. In this embodiment, recesses 778a-c on the upper surface of the holder 710 provide weight savings.

In an alternative embodiment, actuator(s) 722/752 are positioned above the recesses 778a-c to control movement of piston(s) 716 to urge the workpiece element(s) 712 downwards so that they are substantially flush with the lower face 714a of the holder 710. When the holder insert 770 is placed into the holder 710, the upper surfaces of the workpiece elements 712 that are retained in portions 772a-c of the holder insert 770 may be in alignment with the recessed 778a-c and are thus exposed. In this example the piston(s) 716 come into contact with the upper surface of the workpiece elements 712. Alternatively, the piston(s) 716 come into contact with an upper surface of the holder insert 770 (for example against portions of the upper surface of the holder insert 770 positioned between the portions 772a-c).

In embodiments of the present invention, the holder 710 comprises a sensor 790 which is configured to sense a (linear) displacement of workpiece element(s) 712 towards the lapping plate 702 as the workpiece element(s) 712 are urged downwards in operation.

The sensor 790 provides a sensor output signal on connection 780 to the controller 760. It will be appreciated that the connection 780 may be a wired connection or a wireless connection (e.g. via a short-range RF technology such as W-Fi, ZigBee or Bluetooth).

The sensor 790 may take various forms, and persons skilled in the art will understand that a suitable location of the sensor 790 in the holder 710 is dependent on the type of sensor technology employed by the sensor 790.

The sensor 790 may comprise a spring and a transducer which detects displacement of the spring to sense the displacement of the workpiece element(s) 712 towards the lapping plate 702. In this example, the sensor is located in the holder 710 such that the spring extends as the workpiece element(s) 712 are urged downwards,

In another example the lapping plate 702 may comprise a conductive material (the conductive material be embedded in or on the structure of the lapping plate 702, for example the conductive material may be positioned on a lower surface of the lapping plate 702 (the opposing surface to that which abrasive slurry passes over in the lapping process). In this example, the sensor 790 may be a capacitance sensor configured to measure a change in capacitance between the sensor and the conductive material to sense the displacement of the workpiece element towards said lapping plate. As shown in FIG. 13A, the sensor 790 may be located between the piston 416 and the workpiece element(s) 712, within the piston 416 itself, or elsewhere in the holder 710.

In yet another example, the sensor 790 may be a linear variable differential transformer (LVDT). As will be appreciated by persons skilled in the art, a LVDT sensor is an inductive type position sensor for measuring linear displacement whose output is proportional to the position of its moveable core with respect to multiple coils. In this example, the sensor is located in the holder 710 such that the armature core of the LVDT moves linearly as the workpiece element(s) 712 are urged downwards,

In yet another example, the sensor 790 may be an active sensor which transmits a probing waveform and then uses a reflection of that waveform received back at the sensor to detect the displacement of the workpiece element(s) 712 towards the lapping plate 702. The active sensor may take many forms.

For example the active sensor 790 may be a photoelectric sensor that functions using the projection and detection of light (e.g. infra-red, microwaves etc.) Alternatively, the active sensor 790 may be an ultrasonic sensor that functions by using the projection and detection of sound. It will be appreciated that the active sensor 790 needs to be located to have a line of sight to the upper surface of at least one workpiece element 712 as shown in FIG. 13B. The holder 710 may comprise a suitable sensor mount to achieve this line of sight.

It will be appreciated that one or more of the above-identified sensor technologies may be employed in embodiments of the invention. Other sensor technologies suitable for detecting linear displacement will be apparent to persons skilled in the art and are therefore not discussed in detail here.

The system controller 760 may be arranged to control the lapping machine (in particular the rotational speed of the lapping plate 702) based on the sensed displacement of the workpiece elements 712 towards the lapping plate 702. As shown in FIG. 12 the system controller 760 is coupled to the lapping machine by way of connection 782 which may be a wired or wireless connection.

As explained above, the controller 760 has a user interface 762. This allows a user to input a target displacement (corresponding to the amount of material they want to be removed from the workpiece elements 712).

The system controller 760 is able to continually monitor displacement of the workpiece elements 712 towards the lapping plate 702 based on the sensor signal received from the sensor 790. Upon detecting that the target displacement has been reached, the system controller 760 transmits a control signal via connection 782 to the lapping machine to stop rotation of the lapping plate 702.

The user interface 762 also allows a user to input one or more threshold displacement values. Upon detecting that a threshold displacement has been reached, the system controller 760 may transmit a control signal via connection 782 to the lapping machine to reduce the rotational speed (to a non-zero rotational speed) of the lapping plate 702. This achieves improved sensitivity as the amount of material removed approaches the target amount.

In embodiments, the system controller 760 is arranged to control the adjustable actuator 722/752 based on the sensed displacement of the workpiece elements 712 towards the lapping plate 702.

Upon detecting that a threshold displacement has been reached, the system controller 760 may transmit a control signal via connection 764 to the actuator(s) 722/752 to control the linear motion (the degree of applied force) of the workpiece elements 712 upwards, hence relieving pressure onto the workpiece element(s) 712 against the lapping plate 702 during the abrasion process. This again achieves improved sensitivity as the amount of material removed approaches the target amount.

The system controller 760 is able to continually monitor the force or pressure, exerted on the workpiece element(s) 712 based on the pressure signal received from the pressure sensor 756 or indirectly based on the displacement of the workpiece throughout the lapping process. The connection between the pressure sensor 756 and the controller 760 is shown in FIG. 10B as connection 758 and in FIG. 12 as one of the connections 780.

As shown in FIG. 12, the apparatus 700/750 may comprise an abrasive fluid dispensing unit (ADU) 786 configured to dispense an abrasive fluid between the lapping plate 702 and the workpiece element(s) 712. The ADU 786 may be a component of the lapping machine referred to above or a separate unit entirely. In operation, the ADU 786 dispenses an abrasive fluid (often termed “slurry”) which comprises abrasive particles between the workpiece element(s) 712 and the lapping plate 702. The ADU 786 dispenses an abrasive fluid in accordance with a flow rate.

The controller 760 is coupled to the ADU 786 by way of a connection 784 which may be a wired or wireless connection.

The holder 710 may comprise a humidity sensor 773 configured to output a humidity sensor signal to the system controller on connection 780. Whilst the humidity sensor 773 is shown in FIG. 12 as being located in the holder insert 770 it will be appreciated that this is merely an example and in other arrangements may be located elsewhere, for example in the workpiece element mount 714.

The controller 760 is configured to control the flow rate of the dispensed abrasive fluid in dependence on the humidity sensor signal output by the humidity sensor 773, by transmission of a control signal via connection 784 to the ADU 786.

The controller 760 is configured to control the flow rate proportionally to the detected humidity. If the controller 760 detects that the humidity has exceeded an upper humidity threshold, the system controller 760 transmits a control signal via connection 782 to the lapping machine to stop rotation of the lapping plate 702. This is because the inventors have identified that high humidity causes an aquaplaning effect and thus poor abrasion performance. If the controller 760 detects that the humidity has dropped below a lower humidity threshold, a control signal is sent to the ADU 786 to increase the flow rate in order to increase humidity within the specified limits. The user interface 762 also allows a user to input one or more threshold humidity values.

In an alternative arrangement, the humidity sensor signal output by the humidity sensor 773 is transmitted directly to the ADU 786 and a control unit (not shown in FIG. 12) of the ADU 786 operates as described above to control the flow rate of the dispensed abrasive fluid.

A lapping plate 702 having an active radius (or the surface of lapping plate available for the process) substantially corresponding to the diameter of the holder 710 will typically be selected. To ensure an even wearing of the lapping plate 702, a plurality of ceramic portions 720 may be provided around the outer perimeter of the lower surface 714a of the workpiece element mount 714 which are intended to wear (and cause wear to the lapping plate 702) in a similar manner to the workpiece element(s) 712.

One or more portions 720′ may be made of thermochromic material. The portion(s) 720′ may be made of ceramic or any other material having thermochromic properties. Alternatively, the portion(s) 720′ may be painted with thermochromic paint. Thus, the portion(s) 720′ change colour in response to temperature fluctuations thereby providing a visual indication to a user that the temperature has exceeded a threshold temperature and thus that rotation of the lapping plate 702 should be stopped.

In embodiments in which connection 780 is a wired connection, as shown in FIG. 12 an arm 779 may be fixed to the lapping machine and to the sensor 790 (or a connector thereto). In operation the workpiece element mount 714 may rotate (or not) in addition to the lapping plate 702 rotating. In scenarios where the workpiece element mount 714 rotates in operation, the arm 779 may prevent the sensor 790 from rotating and thus prevents the wire between the sensor 790 and system controller 760 from becoming tangled. Alternatively the sensor 790 may rotate with the workpiece element mount 714, and the arm 779 is fixed to a connector coupled to the sensor 790 (the connector providing connection 780) to prevent the wire between the sensor 790 and system controller 760 from becoming tangled. It will be appreciated that the position of the sensor 790 shown in FIG. 12 is merely an example.

Whilst embodiments have been described above with reference to using the apparatus 700/750 to manufacture a ceramic filter from a ceramic filter element, this is merely an example work product that may be manufactured from a workpiece element mounted into the holder 710. Workpiece elements made of other materials (other than ceramic) may be mounted into the holder 710 to manufacture work products made of these other materials.

Whilst use of a model has been described above with reference to embodiments in which the apparatus 700/750 is used to control a filter channel opening size of a ceramic filter element, a model may also be used by the system controller 760 in embodiments in which the apparatus 700/750 is used to control a thickness of workpiece elements made of other materials (other than ceramic).

For example a user may input parameters, via the user interface 762, such as the surface roughness of the workpiece element 712 (typically measured using the unit tau), a target thickness of the work product that is to be manufactured from the workpiece element 712, and tolerance information. The system controller 760 may be configured to use a model to compute a target displacement (corresponding to the amount of material to be removed from the workpiece element 712) from these input parameters.

No doubt many other effective alternatives will occur to the skilled person. It will be understood that the invention is not limited to the described embodiments and encompasses modifications apparent to those skilled in the art lying within the spirit and scope of the claims appended hereto.

Examples are defined in clauses A1-A19 below:

A1. Apparatus for controlling the filter channel opening size of a ceramic filter element, said ceramic filter element having flared pores, the apparatus comprising:

a lapping machine having a lapping plate; and

a filter holder to hold a ceramic filter element for controlled lapping of said flared pores;

wherein said filter holder comprises:

a filter element mount to mount a filter element to be lapped such that a surface of said filter element lies substantially flush with a lower face of said filter holder;

an adjustable actuator to controllably move said surface of said filter element so that it remains substantially flush or projects beyond said lower face of said filter holder during lapping; and

means for urging said filter holder towards said lapping plate.

A2. Apparatus as set forth in clause A1 wherein said filter element mount comprises a piston adjustable within said filter holder by said actuator.
A3. Apparatus as set forth in clause A2 further comprising a seal between said piston and said filter holder.
A4. Apparatus as set forth in clause A2 or A3 wherein said actuator comprises a micrometer screw thread.
A5. Apparatus as set forth in any one of clauses A1 to A4 wherein said lower face of said filter holder includes a ceramic portion extending around a perimeter of the filter element, when mounted.
A6. Apparatus as set forth in any preceding clause wherein said means for urging said filter holder towards said lapping plate comprises one or more weights mounted on said filter holders
A7. Apparatus as set forth in any preceding clause further comprising movement control means, in particular a stop for said actuator, to control a degree of abrasion of said filter element to control an opening size of said flared pores.
A8. Apparatus as set forth in any preceding clause further comprising a system controller, wherein the system controller is configured to:

sense or measure one or more parameters selected from the group consisting of: a pressure of said filter element on said lapping plate, a rotational speed of said lapping plate, and a duration of lapping of said filter element; and

control one more of said parameters to control said filter channel opening size.

A9. Apparatus as set forth in clause A8 wherein said system controller comprises a stored model relating one more of said sensed parameters to said filter channel opening size.
A10. Apparatus as set forth in clause A9 wherein said stored model comprises a mathematical model.
A11. Apparatus as set forth in clause A9 wherein said stored model comprises an empirical model.
A12. A method of manufacturing a ceramic filter, comprising using the apparatus of any preceding claim to controllably remove a portion of the thickness of a surface of a ceramic filter element having flared pores opening onto said surface, to thereby control a channel opening size of said ceramic filter.
A13. A method as set forth in clause A12 further comprising fabricating said ceramic filter element by sintering a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex; and wherein said sintering comprises applying a force to said ceramic precursor element during said sintering, wherein said force has a component in a direction from said apex towards said base of said flared pore.
A14. A method of manufacturing a ceramic filter having a controlled filter channel opening size, the method comprising:

sintering a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex,

wherein said sintering comprises applying a force to said ceramic precursor element during said sintering, wherein said force has a component in a direction from said apex towards said base of said flared pore; and

fabricating said ceramic filter by removing a controlled thickness portion of said flat surface to open said flared pores to said controlled filter channel opening size.

A15. A method as set forth in clause A13 or A14 comprising applying said force to maintain said ceramic precursor element substantially flat during said sintering.
A16. A method as set forth in clause A13, A14 or A15 comprising applying said force using the weight of a ceramic material.
A17. A method as set forth in clause A13, A14, A15 or A16 wherein, in said ceramic precursor, said flared pore contains polymer material and regions between said flared pores comprise ceramic material; and wherein said sintering fuses said ceramic material and removes said polymer material.
A18. A method as set forth in any one of clauses A13 to A17 comprising fabricating said ceramic precursor element by forming a dope into a desired shape for the element, the dope comprising the ceramic material, the polymer, and a solvent for the polymer; and treating the formed shape in a bath of liquid to at least partially replace the solvent with the liquid of said bath.
A19. A method as set forth in clause A18 further comprising degassing said dope prior to forming said dope into said desired shape.

1. Apparatus for controlling a thickness of a workpiece element, the apparatus comprising:
a lapping machine having a lapping plate; and
a holder to hold a workpiece element;
wherein said holder comprises:
a workpiece element mount to mount a workpiece element to be lapped such that a surface of said workpiece element lies substantially flush with a lower face of said holder;
an adjustable actuator to controllably move said surface of said workpiece element so that it remains substantially flush or projects beyond said lower face of said holder during lapping;
means for urging said holder towards said lapping plate; and
a sensor for sensing a displacement of the workpiece element towards said lapping plate.

2. Apparatus as claimed in claim 1 wherein said workpiece element mount comprises a piston adjustable within said holder by said actuator.

3. Apparatus as claimed in claim 2 further comprising a seal between said piston and said holder.

4. Apparatus as claimed in claim 2 wherein said actuator comprises a micrometer screw thread.

5. Apparatus as claimed in claim 1 wherein said lower face of said holder includes a ceramic portion extending around a perimeter of the workpiece element, when mounted.

6. Apparatus as claimed in claim 1 wherein said means for urging said holder towards said lapping plate comprises one or more weights mounted on said holder.

7. Apparatus as claimed in claim 1 further comprising movement control means, in particular a stop for said actuator, to control a degree of abrasion of said workpiece element.

8. Apparatus as claimed in claim 1 wherein the workpiece element mount is arranged to mount a plurality of workpiece elements to be lapped.

9. Apparatus as claimed in claim 1 further comprising a system controller arranged to receive a sensor signal output by said sensor, the sensor signal indicative of the displacement of the workpiece element towards said lapping plate.

10. Apparatus as claimed in claim 9, wherein the system controller is arranged to control the lapping machine based on the sensed displacement of the workpiece element towards said lapping plate.

11. Apparatus as claimed in claim 10, wherein the system controller is arranged to control the rotational speed of said lapping plate based on the sensed displacement of the workpiece element towards said lapping plate.

12. Apparatus as claimed in claim 10, wherein the system controller is arranged to transmit a control signal to the lapping machine to stop rotation of the lapping plate upon detection that the sensed displacement has reached a target displacement.

13. Apparatus as claimed in claim 9, wherein the system controller is arranged to control the adjustable actuator based on the sensed displacement of the workpiece element towards said lapping plate.

14. Apparatus as claimed in claim 13, wherein the system controller is arranged to reduce a pressure exerted on the workpiece element by the adjustable actuator upon detection that the sensed displacement of the workpiece element towards said lapping plate is greater than one or more threshold displacement values.

15. Apparatus as claimed in claim 1 wherein the sensor comprises a spring and a transducer which detects displacement of the spring to sense the displacement of the workpiece element towards said lapping plate.

16. Apparatus as claimed in claim 1 wherein the lapping plate comprises a conductive material and the sensor is a capacitance sensor configured to measure a change in capacitance between the sensor and the conductive material to sense the displacement of the workpiece element towards said lapping plate.

17. Apparatus as claimed in claim 1 wherein the sensor is a linear variable differential transformer.

18. Apparatus as claimed in claim 1 wherein the sensor is an ultrasonic sensor.

19. Apparatus as claimed in claim 1 wherein the sensor is a photoelectric sensor.

20. Apparatus as claimed in claim 1, the apparatus further comprising an abrasive fluid dispensing unit configured to dispense an abrasive fluid between the lapping plate and the workpiece element, wherein said holder further comprises a humidity sensor and a flow rate of the dispensed abrasive fluid is controlled in dependence on a humidity sensor signal output by said humidity sensor.

21. Apparatus as claimed in claim 9 wherein the system controller is configured to:
sense or measure one or more parameters selected from the group consisting of: a pressure of said workpiece element on said lapping plate, a rotational speed of said lapping plate, and a duration of lapping of said workpiece element; and
control one more of said parameters to control the thickness of the workpiece element.

22. Apparatus as claimed in claim 21 wherein the workpiece element is a ceramic filter element having flared pores and said system controller comprises a stored model relating one more of said sensed parameters to a filter channel opening size of the ceramic filter element.

23. Apparatus as claimed in claim 22 wherein said stored model comprises a mathematical model.

24. Apparatus as claimed in claim 22 wherein said stored model comprises an empirical model.

25. A method of manufacturing a work product, comprising using the apparatus of claim 1 to controllably remove a portion of the thickness of a surface of a workpiece element to thereby control a thickness of the work product.

26. A method of manufacturing a ceramic filter, comprising using the apparatus of claim 1 to controllably remove a portion of the thickness of a surface of a ceramic filter element having flared pores opening onto said surface, to thereby control a channel opening size of said ceramic filter.

27. A method as claimed in claim 26 further comprising fabricating said ceramic filter element by sintering a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex; and wherein said sintering comprises applying a force to said ceramic precursor element during said sintering, wherein said force has a component in a direction from said apex towards said base of said flared pore.

28. A method of manufacturing a ceramic filter having a controlled filter channel opening size, the method comprising:
sintering a ceramic precursor element, said precursor element having a structure comprising first and second surfaces and an arrangement of flared pores extending between said first and second surfaces, wherein an apex of a said flared pore is towards said first surface and a base of said flared pore is towards said second surface and is larger than said apex,
wherein said sintering comprises applying a force to said ceramic precursor element during said sintering, wherein said force has a component in a direction from said apex towards said base of said flared pore; and
fabricating said ceramic filter by removing a controlled thickness portion of said flat surface to open said flared pores to said controlled filter channel opening size.

29. A method as claimed in claim 28 comprising applying said force to maintain said ceramic precursor element substantially flat during said sintering.

30. A method as claimed in claim 28 comprising applying said force using the weight of a ceramic material.

31. A method as claimed in claim 28 wherein, in said ceramic precursor, said flared pore contains polymer material and regions between said flared pores comprise ceramic material; and wherein said sintering fuses said ceramic material and removes said polymer material.

32. A method as claimed in claim 28 comprising fabricating said ceramic precursor element by forming a dope into a desired shape for the element, the dope comprising the ceramic material, the polymer, and a solvent for the polymer; and treating the formed shape in a bath of liquid to at least partially replace the solvent with the liquid of said bath.

33. A method as claimed in claim 32 further comprising degassing said dope prior to forming said dope into said desired shape.
